(19) United States
(12) Patent Application Publication
(10) Pub. No.: US 2014/0187402 A1
(43) Pub. Date: Jul. 3, 2014

(54) METHOD FOR HEAT SEALING ZIPPER TAPE, METHOD FOR MANUFACTURING FILM ROLL HAVING ZIPPER TAPE, AND METHOD FOR MANUFACTURING PACKAGING HAVING ZIPPER TAPE

(71) Applicant: IDEMITSU UNITECH CO., LTD., Minato-ku, Tokyo (JP)

(72) Inventors: Shuichi Goto, Minato-ku (JP); Ryo Katada, Sodegaura-shi (JP)

(73) Assignee: IDEMITSU UNITECH CO., LTD., Minato-ku (JP)

(21) Appl. No.: 14/122,430

(22) PCT Filed: May 30, 2012
(86) PCT No.: PCT/JP12/63856

§ 371 Date: Nov. 26, 2013

(30) Foreign Application Priority Data
May 31, 2011 (JP) 2011-122406

(51) Int. Cl. B31B 1/90; B31B 37/00; B31B 1/64

(52) U.S. Cl. CPC B31B 1/90; B31B 1/64; B31B 37/00
USPC 493/213; 493/208; 493/214

(57) ABSTRACT

A heat sealing method of a zipper tape is for heat sealing the zipper tape in a direction perpendicular to a feeding direction of a film. The heat sealing method includes: inserting the zipper tape between the film and a circumference of a roller on which the film is wound; and heat sealing the zipper tape to the film with a seal bar following a rotation of the roller in a continuous manner, while the zipper tape is interposed between the circumference of the roller and the film.

### TECHNICAL FIELD

The present invention relates to a heat sealing method of a zipper tape, a manufacturing method of a zipper-tape-attached film roll, and a manufacturing method of a packaging bag provided with a zipper tape.

### BACKGROUND ART

There has typically been known a packaging bag provided with a zipper tape (hereinafter, occasionally abbreviated as a “packaging bag”) that is provided by heat sealing the zipper tape to an inner surface of a film (see Patent Literature 1).

In a heat sealing method of a zipper tape disclosed in Patent Literature 1, the zipper tape is placed in a traverse direction relative to a moving direction of the film and heat-sealed.

### CITATION LIST

### Patent Literature(s)

Patent Literature 1 JP-A-2005-8231

### SUMMARY OF THE INVENTION

### Problems to be Solved by the Invention

However, in the heat sealing method of the zipper tape disclosed in Patent Literature 1, since heat sealing is conducted intermittently as described in FIG. 8 of Patent Literature 1, feeding of the film needs to be stopped during the heat sealing Accordingly, production efficiency cannot be improved.

Moreover, since the zipper tape is simply placed on the film, a position of the zipper tape is shifted during heat sealing, so that the zipper tape may not be heat-sealed at a predetermined position.

An object of the invention is to provide a heat sealing method of a zipper tape capable of improving production efficiency and further preventing shifting of a position of the zipper tape to be heat-sealed, a manufacturing method of a zipper-tape-attached film roll, and a manufacturing method of a packaging bag provided with a zipper tape.

### Means for Solving the Problems

According to an aspect of the invention, a heat sealing method of a zipper tape in a direction perpendicular to a feeding direction of a film includes: inserting the zipper tape between the film and a circumference of a roller on which the film is wound; and heat sealing the zipper tape to the film with a seal bar following a rotation of the roller in a continuous manner, while the zipper tape is interposed between the circumference of the roller and the film.

According to the above aspect of the invention, since the seal bar follows rotation of the roller, it is not necessary to stop feeding of the film. Accordingly, since the zipper tape can be heat-sealed while the film is continuously fed, production efficiency can be improved.

Moreover, according to the above aspect of the invention, since the zipper tape is heat-sealed while being sandwiched between the circumference of the roller and the film, the position of the zipper tape is not shifted. Accordingly, since the zipper tape can be heat-sealed at a predetermined position, shifting of a position of the zipper tape to be heat-sealed can be prevented.

According to the above aspect of the invention, since heat sealing is conducted while the seal bar is following the rotation of the roller, a welding time can be prolonged as compared with an instance where intermittent heat-sealing is conducted at a halt of feeding of the film. Accordingly, the zipper tape can be reliably heat-sealed.

It should be noted that heat sealing on the circumference of the roller may be temporary (pseudo-adhesive). In this case, the zipper tape only needs to be strongly heat-sealed at a later stage.

According to another aspect of the invention, a manufacturing method of a zipper-tape-attached film roll includes: attaching the zipper tape in parallel to a width direction of the film roll using the heat sealing method of the zipper tape according to the above aspect of the invention.

According to the above aspect of the invention, since the aforementioned heat sealing method is conducted, a zipper-tape-attached film roll can be produced at an excellent production efficiency without shifting of a position of the zipper tape to be heat-sealed.

According to still another aspect of the invention, a manufacturing method of a packaging bag provided with a zipper tape includes making the packaging bag using the zipper-tape-attached film roll that is manufactured by the manufacturing method of the zipper-tape-attached film roll according to the above aspect of the invention.

According to a further aspect of the invention, a manufacturing method of a packaging bag provided with a zipper tape includes: attaching the zipper tape in parallel to a width direction of the film roll using the heat sealing method of the zipper tape according to the above aspect of the invention; and making the packaging bag using the zipper-tape-attached film roll.

In the above aspect of the invention, it is preferable that a pillow bag is made in the making of the packaging bag.

The above bag-making is applicable to any packaging bag-making methods such as a three-side packaging bag-making method and a pillow packaging bag-making method. However, when the bag-making according to the above aspect of the invention is applied to the pillow packaging bag-making method, packaging bag-making efficiency can be particularly improved.

According to the above aspect of the invention, since the aforementioned heat sealing method is conducted, the packaging bag provided with the zipper tape can be produced at an excellent production efficiency without shifting of a position of the zipper tape to be heat-sealed.

### BRIEF DESCRIPTION OF DRAWINGS

FIG. 1 is a front view showing a packaging bag obtained by a manufacturing method of a packaging bag provided with a zipper tape according to an exemplary embodiment.

FIG. 2 is a cross sectional view taken along II-II line of the packaging bag shown in FIG. 1.

FIG. 3 shows a heat sealing method of the zipper tape according to the exemplary embodiment.

FIG. 4 is a perspective view showing a zipper-tape-attached film roll obtained by a manufacturing method of a zipper-tape-attached film roll according to the exemplary embodiment.

FIG. 5 shows packaging bag-making in manufacturing of the packaging bag provided with the zipper tape according to the exemplary embodiment.

FIG. 6A is a cross sectional view of a zipper tape according to another exemplary embodiment.

FIG. 6B is a cross sectional view of a zipper tape according to still another exemplary embodiment.

FIG. 6C is a cross sectional view of a zipper tape according to a further exemplary embodiment.

### DESCRIPTION OF EMBODIMENT(S)

An exemplary embodiment of the invention will be described below with reference to the attached drawings.

A pillow packaging bag manufactured by a manufacturing method of a packaging bag provided with a zipper tape according to the exemplary embodiment is suitably used for being filled with contents such as liquid, powder and gel. The pillow packaging bag may also be used for packaging various articles such as food, medicine, medical products, cosmetics and miscellaneous goods. It should be noted that kinds of the contents and use of the packaging bag are not limited to the above.

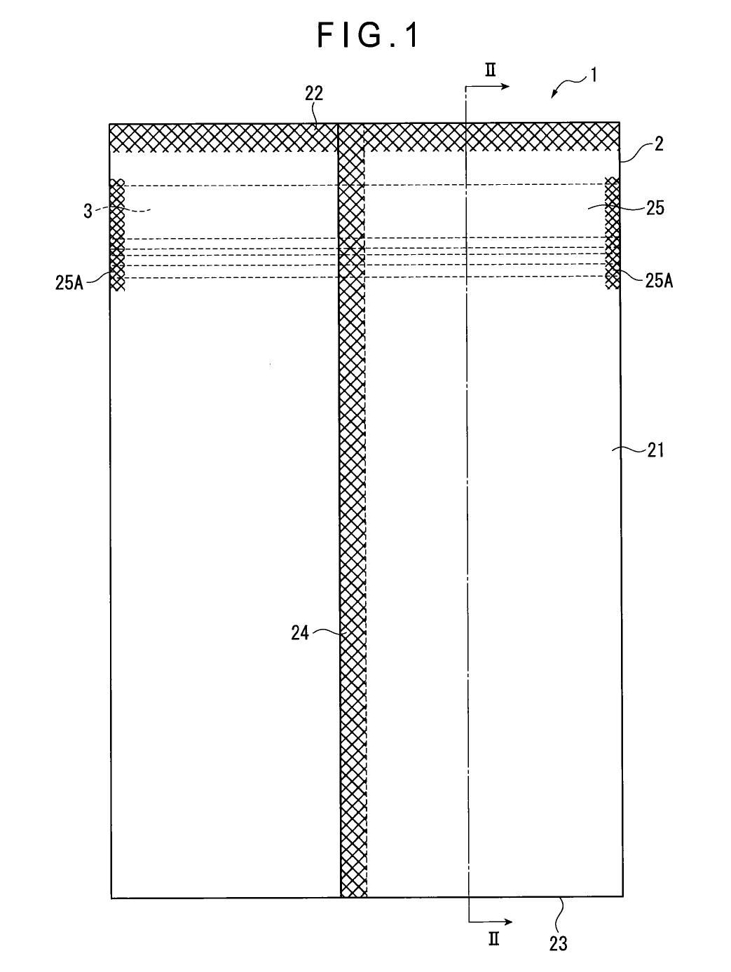

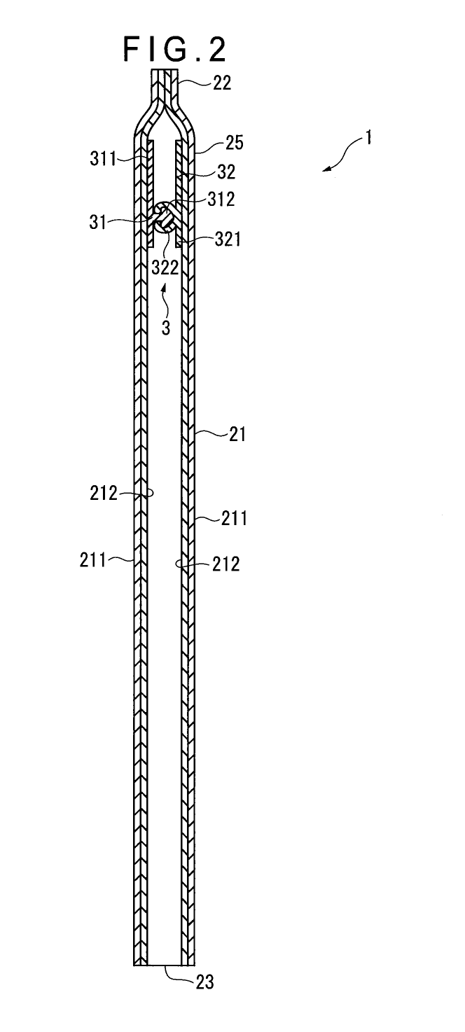

As shown in FIGS. 1 and 2, a pillow packaging bag 1 includes a bag body 2 and a zipper tape 3 that is heat-sealed on an inner surface of the bag body 2.

The bag body 2 is formed by layering ends of a sheet of film 21. The bag body 2 includes a top seal portion 22 that is formed at an upper end, an opening 23 that is formed at a lower end and is to be bottom-sealed after contents are fed, and a backlining portion 24 that extends from the top seal portion 22 to the opening 23.

The bag body 2 includes a tape seal portion 25 that is provided near the top seal portion 22 and on which the zipper tape 3 is heat-sealed. At both ends of the tape seal portion 25, a point seal portion 25A for preventing leakage of the contents from an inside of the pillow packaging bag 1 is provided.

As shown in FIG. 2, the film 21 is provided in a form of a laminate film in which a sealant layer 212 is laminated on a base layer 211. As the base layer 211, for instance, a biaxially-oriented polyester film, a biaxially-oriented nylon film, a biaxially-oriented polyolefin film and the like may be used. As the sealant layer 212, for instance, a low density polyethylene may be used.

The zipper tape 3 is heat-sealed on the inner surface of the bag body 2 near the top seal portion 22. The zipper tape 3 includes a male belt-shaped portion 31 and a female belt-shaped portion 32.

The male belt-shaped portion 31 includes: a male belt-shaped base 311 that is heat-sealed on the sealant layer 212 of the bag body 2; and a male engagement portion 312 that is formed on the male belt-shaped base 311 and is substantially in an arrowhead shape.

Similar to the male belt-shaped portion 31, the female belt-shaped portion 32 includes: a female belt-shaped base 321; and a concave female engagement portion 322 that is engageable and disengageable with the male engagement portion 312.

Such a zipper tape 3 may be formed using a polyolefin resin such as polyethylene and polypropylene.

Heat Sealing Method of Zipper Tape, Manufacturing Method of Zipper-Tape-Attached Film Roll, And Manufacturing Method of Packaging Bag with Zipper Tape

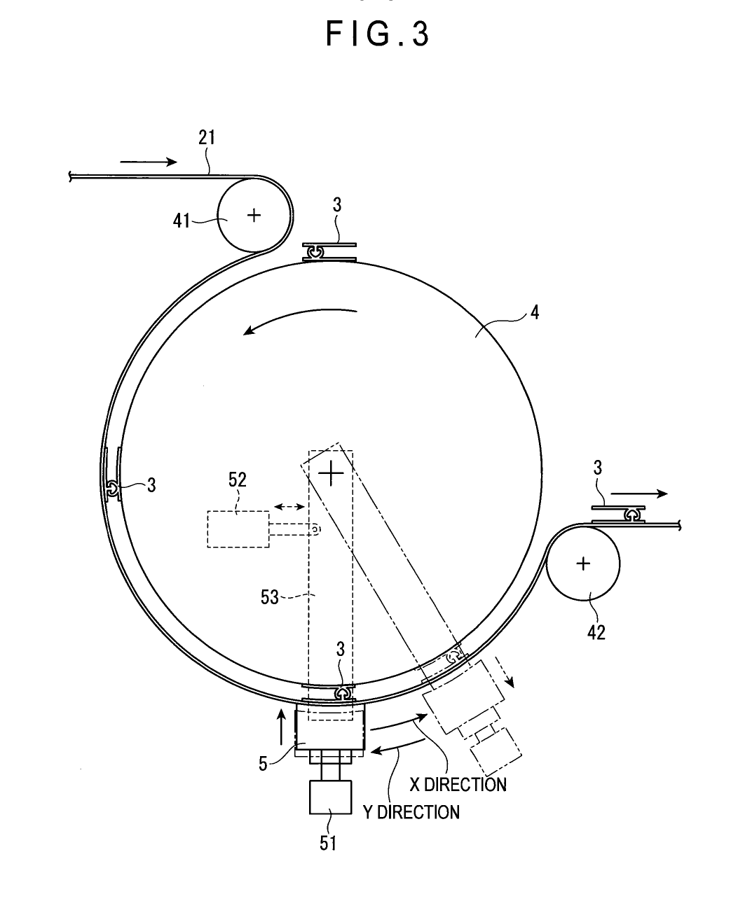

Next, a heat sealing method of the zipper tape according to the exemplary embodiment (hereinafter, occasionally abbreviated as a “heat sealing method”) will be described with reference to FIG. 3.

As shown in FIG. 3, the heat sealing method of the zipper tape includes inserting and heat sealing.

Firstly, the film 21 is fed from a film roll (not shown). The film 21 is sequentially fed into a gap between a roller 4 and a first small roller 41, a gap between the roller 4 and a seal bar 5, and a gap between the roller 4 and a second small roller 42, whereby the film 21 is wound on the roller 4. On the other hand, the zipper tape 3 is fed from a tape roll (not shown) and is cut substantially in the same length as a width of the pillow packaging bag 1 (see FIG. 1).

In inserting, the cut zipper tape 3 is intermittently placed on the circumference of an upper portion of the roller 4. The placed zipper tape 3 is inserted between the circumference of the roller 4 and the film 21 by rotation of the roller 4. Herein, the zipper tape 3 may be positioned by being inserted between the roller 4 and the film 21 using an insertion plate as a means for inserting Another means for inserting is exemplified by a mechanism that the zipper tape 3 is automatically inserted between the roller 4 and the film 21 by positioning the zipper tape 3 by means of sucking the zipper tape 3 from a suction hole (not shown) provided on the circumference of the roller 4 while the zipper tape 3 is placed on an upper surface of the film 21.

The zipper tape 3 is moved along the circumference of the roller 4 while being sandwiched between the film 21 and the roller 4.

In heat sealing, when the zipper tape 3 is disposed in a gap against the seal bar 5 after the zipper tape 3 is moved while being sandwiched between the roller 4 and the film 21, the seal bar 5 is pressed onto the roller 4 by a first air cylinder 51 attached to a plate 53, whereby the film 21 and the zipper tape 3 are heat-sealed to each other while the seal bar 5 is following the rotation of the roller 4.

Herein, the seal bar 5 is fixed to a tip end of the plate 53 that is slidable by a second air cylinder 52 in a rotation direction of the roller 4. When the seal bar 5 is pressed onto the roller 4, the seal bar 5 follows the rotation of the roller 4 to move (in an X direction in FIG. 3). When the seal bar 5 is separated from the roller 4, the seal bar 5 returns to an initial position (in a Y direction in FIG. 3).

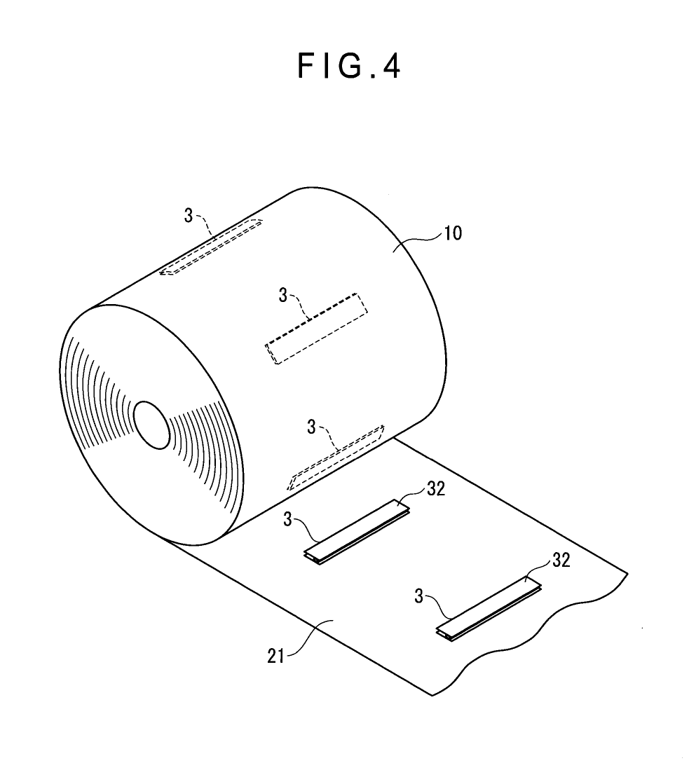

By thus using the aforementioned heat sealing method, a zipper-tape-attached film roll 10 in which the zipper tape 3 is attached to the roll in a width direction can be obtained as shown in FIG. 4. It should be noted that the aforementioned inserting and heat sealing constitute attaching in a manufacturing method of the zipper-tape-attached film roll.

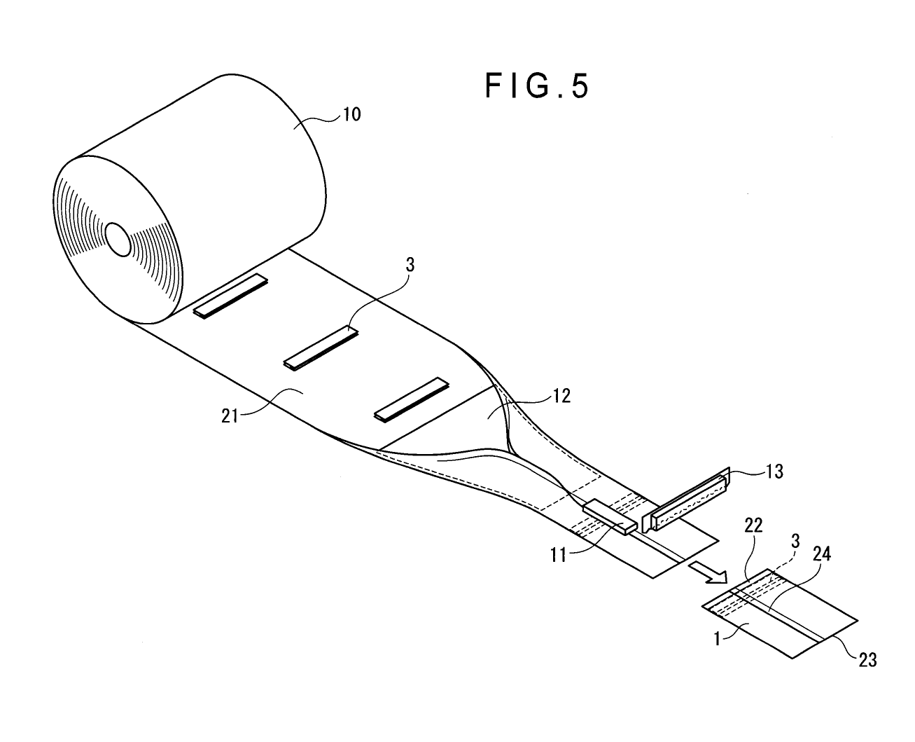

Subsequently, a manufacturing method of the packaging bag provided with the zipper tape according to the exemplary embodiment will be described with reference to FIG. 5.

Firstly, bag-making (pillow bag-making) is conducted by feeding the film 21 from the zipper-tape-attached film roll 10, layering lateral ends of the film 21 on each other, and backlining-sealing the layered lateral ends of the film 21 using a center press 11. Herein, a guide plate 12 is used for layering the lateral ends of the film 21.

Next, using a heat seal bar 13 disposed in parallel to the width direction of the film 21, both ends of the zipper tape 3 are point-sealed and the film 21 above the zipper tape 3 is top-sealed.

Subsequently, the film 21 on an upper stream side of the top seal portion is cut. The film 21 near the attached zipper tape (near the top seal portion) is heat-sealed while a side opposite to the top seal portion of the film 21 is opened, thereby manufacturing a pillow packaging bag 1.

The thus obtained pillow packaging bag 1 is used by being heat-sealed (bottom-sealed) after being filled with contents through the opening 23.

### Advantages of Embodiment(s)

(1) In heat sealing according to the exemplary embodiment, since the seal bar 5 follows the rotation of the roller 4, it is not necessary to stop feeding the film 21 for heat sealing the zipper tape 3 on the film 21. Accordingly, the zipper tape 3 can be heat-sealed while the film 21 is kept being fed, so that production efficiency can be improved.
(2) Moreover, since the zipper tape 3 is heat-sealed while being sandwiched between the circumference of the roller 4 and the film 21, the position of the zipper tape is not shifted. Accordingly, the zipper tape 3 can be heat-sealed at a predetermined position.
(3) Since the zipper tape 3 is heat-sealed while the seal bar 5 follows, a welding time can be prolonged. Accordingly, the zipper tape 3 can be reliably heat-sealed.
(4) In the manufacturing method of the zipper-tape-attached film roll according to the exemplary embodiment, since the above heat sealing method is used, the production efficiency can be improved and the zipper-tape-attached film roll 10 can be manufactured without shifting of a position of the zipper tape to be heat-sealed.
(5) In the manufacturing method of the packaging bag provided with the zipper tape according to the exemplary embodiment, since the zipper-tape-attached film roll 10 obtained by the above heat sealing method is used, the production efficiency can be improved and the pillow packaging bag 1 can be manufactured without shifting of the position of the zipper tape to be heat-sealed.

### Modification

The scope of the invention is not limited to the above-described embodiments but also includes modifications and improvements as long as an object of the invention can be achieved.

The zipper tape according to the above exemplary embodiment is exemplified by the zipper tape without a cutting portion as shown in FIGS. 1 and 2. However, the zipper tape is not limited thereto. A zipper tape with a cutting portion may be used, the cutting portion including a male belt-shaped portion and a female belt-shaped portion, each of which partially include a thick portion and a thin portion, in which the thin portion is cut.

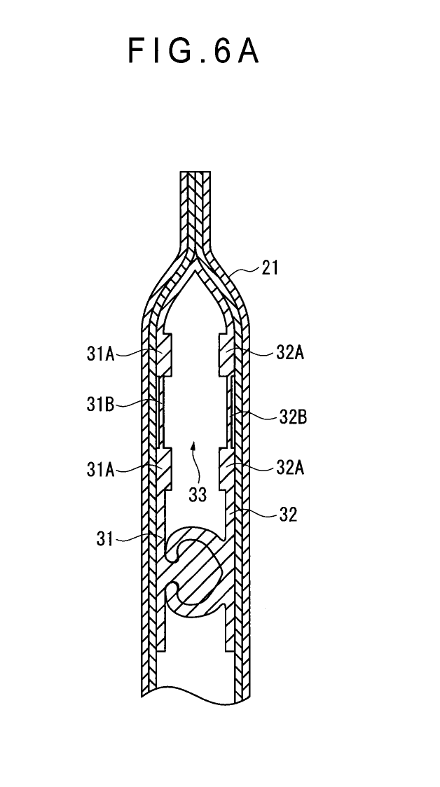

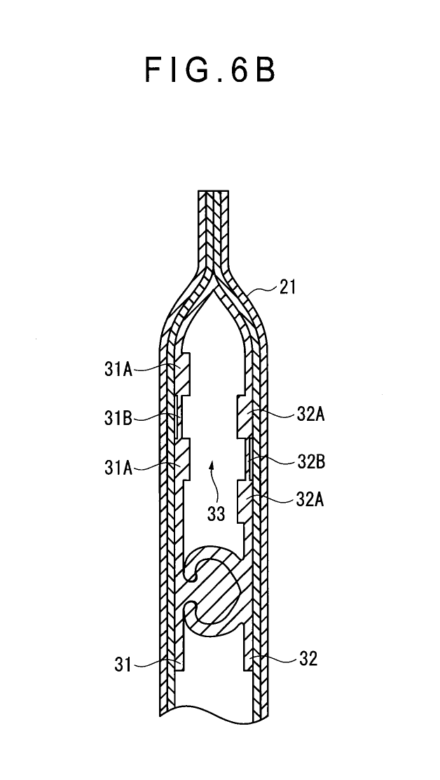

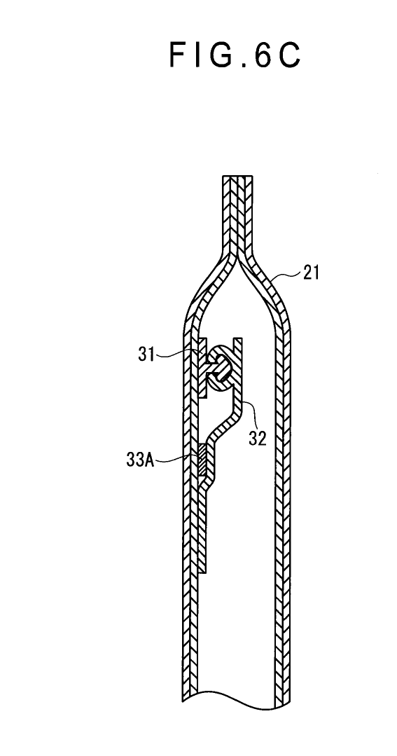

Herein, in a cutting portion 33 that is provided at a part of each of a male belt-shaped portion 31 and a female belt-shaped portion 32, thin portions 31B and 32B may be disposed in the same height in a cross sectional view as shown in FIG. 6A, which allows the thin portions 31B and 32B to be linearly cut, the thin portion 31B being provided between a pair of thick portions 31A while the thin portion 32B being provided between a pair of thick portions 32A. Alternatively, as shown in FIG. 6B, the thin portions 31B and 32B may be disposed in different heights in the cross sectional view, which allows the thin portions 31B and 32B to be cut in different heights.

In the above exemplary embodiment, the male belt-shaped portion and the female belt-shaped portion provided as separate bodies without connecting each other are described. However, the arrangements of the male belt-shaped portion and the female belt-shaped portion are not limited thereto. A male belt-shaped portion and a female belt-shaped portion in a form of partially connected with each other may be used. In this arrangement, by disposing the connected portion on a side the zipper tape to be initially inserted into the roll, the belt-shaped portions can be kept from being peeled in inserting and bag-making.

Further, in the above exemplary embodiment, the zipper tape is described in an arrangement in which the male belt-shaped portion and the female belt-shaped portion are attached to face each other as shown in FIGS. 1 and 2. However, the arrangement of the zipper tape is not limited thereto. As shown in FIG. 6C, the male belt-shaped portion 31 and the female belt-shaped portion 32 may be attached in parallel to a width direction thereof (a vertical direction in FIG. 6C). In this arrangement, a cutting tape 33A is provided between the male belt-shaped portion 31 and the female belt-shaped portion 32, the cutting tape 33A being bonded to the film closer to the female belt-shaped portion 32 in the above exemplary embodiment.

Further, although a single seal bar is provided in the above exemplary embodiment, a plurality of seal bars may be used.

In the above description, a single seal bar heat-seals a single zipper tape. However, by enlarging a width of the seal bar, the single seal bar may heat seal a plurality of zipper tapes.

The seal bar returns to the initial position by the air cylinder after heat sealing the zipper tape. In place of the air cylinder, a spring mechanism, servo motor mechanism and the like may be used.

Although the male belt-shaped portion and the female belt-shaped portion are independently provided, the male belt-shaped portion and the female belt-shaped portion may be connected to each other.

Further, the small roller 42 shown in FIG. 3 for feeding the film 21 may be replaced with a roller having a larger diameter and be used as a cooling roller. The cooling roller may be pressed onto the roller 4, thereby applying pressure to the zipper tape and the film while cooling the zipper tape and the film.

Furthermore, the above exemplary embodiment describes the manufacturing method of the packaging bag (pillow packaging bag) provided with the zipper tape 1 using the film roll to which the zipper tape is attached in parallel to the width direction of the roller. However, the manufacturing method thereof is not limited to the above. As shown in FIG. 3, a packaging bag provided with a zipper tape may be manufactured by attaching a zipper tape to a film roll (not shown) through the aforementioned inserting and heat sealing and then performing the aforementioned bag-making.

Furthermore, though the above exemplary embodiment describes that the heat sealing method of the invention is applied to the manufacturing method of the zipper-tape-attached film roll and the manufacturing method of the packaging bag provided with the zipper tape, the heat sealing method of the invention may alternatively be applied to a manufacturing method of an automatically packaging fill-in bag provided with a zipper tape.

Other specific arrangements and shapes for carrying out the invention may be altered as long as an object of the invention is achieved.

### INDUSTRIAL APPLICABILITY

The invention is applicable as a manufacturing method of a packaging bag for packaging various articles such as foods, pharmaceutical and medical products, cosmetics and groceries, and a packaging bag.

### EXPLANATION OF CODES

1 pillow packaging bag (packaging bag provided with a zipper tape)
3 zipper tape
4 roller
5 seal bar
10 zipper-tape-attached film roll
21 film

1. A heat sealing method of a zipper tape in a direction perpendicular to a feeding direction of a film, the method comprising:
inserting the zipper tape between the film and a circumference of a roller on which the film is wound; and
heat sealing the zipper tape to the film with a seal bar following a rotation of the roller in a continuous manner, while the zipper tape is interposed between the circumference of the roller and the film.

2. A manufacturing method of a zipper-tape-attached film roll, comprising:
attaching the zipper tape in parallel to a width direction of the film roll using the heat sealing method of the zipper tape according to claim 1.

3. A manufacturing method of a packaging bag provided with a zipper tape, comprising making the packaging bag using the zipper-tape-attached film roll that is manufactured by the manufacturing method of the zipper-tape-attached film roll according to claim 2.

4. A manufacturing method of a packaging bag provided with a zipper tape, comprising:
attaching the zipper tape in parallel to a width direction of the film roll using the heat sealing method of the zipper tape according to claim 1; and
making the packaging bag using the zipper-tape-attached film roll.

5. The manufacturing method of the packaging bag provided with the zipper tape according to claim 3, wherein
a pillow bag is made in the making of the packaging bag.

6. The manufacturing method of the packaging bag provided with the zipper tape according to claim 4, wherein
a pillow bag is made in the making of the packaging bag.
